(19) United States
(12) Patent Application Publication
(10) Pub. No.: US 2011/0258903 A1
(43) Pub. Date: Oct. 27, 2011

(54) FISHING ROD CARRIAGE AND RELATED METHOD OF USE

(76) Inventor: Hector Paredes, Miami, FL (US)

(21) Appl. No.: 12/767,123

(22) Filed: Apr. 26, 2010

(51) Int. Cl. A01K 97/10

(52) U.S. Cl. 43/21.2

(57) ABSTRACT

The invention is directed to a method of retrieving a fishing rod having a reel, a connector and a pole from an rod holder. The method begins by positioning a carriage parallel to the rod holder such that the carriage is below the reel. The carriage includes an opening, a top wall, a bottom wall, a first side wall and a second side wall which form a cavity which can maintain the reel. Two channels located on the top and bottom wall of the engaging member having a first prong, a corresponding second prong and a stopper. The carriage also includes a handle affixed to the engaging member. The second step is to encapsulate the reel with the cavity. Next, the method contemplates contacting a connector of the fishing rod with the stopper. The final step is to lift the handle upward to remove the fishing rod from the rod holder.

### FIELD OF THE INVENTION

The invention relates to a carriage sufficient to engage, remove and position a fishing rod located in difficult to reach fishing rod holders affixed throughout any type of boat. In addition, the invention teaches a method of retrieving and positioning any form of fishing rod located in a remote fishing rod holder.

### BACKGROUND OF THE INVENTION

Offshore boat fishing, also called deep sea or open water fishing, represents a popular recreational sport in the United States. Offshore boat fishing typically includes fishing in water more than 30 meters deep at some distance from land. Specialized knowledge is needed regarding weather patterns, navigation and safety precautions. Accordingly, most offshore boat fishing is conducted by either more experienced, recreational fishermen or through charters with professional guides.

Offshore boats are generally larger than inshore boats and are designed to have sturdy construction to sustain weather and water conditions in open waters. They are also typically more difficult to build and maintain. Accordingly, offshore boat fishing is often a pastime of the affluent and/or caters to vacationers that desire a unique luxurious experience. In addition, the fish typically caught in offshore boat fishing are often more desirable, including marlin and tuna.

Because fish typically caught in offshore boat fishing can be large, heavy tackle and specialized sea rods (also known as downtide rods) must be used. These sea rods include a pole and a reel attached to the poll through a connector. Positioned at the distal end of each pole is a handle—which is typically soft, pliable and contains a suitable gripping surface. While sea rods are often preferred for offshore boat fishing, many shapes, sizes and configurations are often used and employed.

One popular technique used in offshore boat fishing to maximize the chance of catching larger more desirable fish is trolling. Trolling first includes the positioning of a plurality of fishing rods in parallel relation to one another. This position occurs by placing the handle of each fishing rod within either an outrigger or fishing rod holder (hereinafter collectively referred to as a “rod holder”). Each rod holder includes a tubular casing of a sufficient size and dimension to maintain and secure each fishing rod. By positioning multiple rod holders on the boat, the plurality of fishing rods can be secured without need for manual use—while the boat proceeds into deep water to catch fish.

Typically, these rod holders are positioned on the roofs, balconies and sides of larger offshore boats (as well as other related difficult to reach areas) to maximize the number of fishing rods to be used while fishing. Such devices are often positioned in a high enough place to avoid risking fisherman hitting their heads on the various rod holders. However, this often makes it difficult to both position and retrieve the fishing rods from the rod holders. Quick and safe retrieval of the fishing rods is of paramount importance in order to position the pole onto the fisherman to reel in a hooked fish.

Accordingly, there is a need in the field of offshore boat fishing for a device that allows quick, safe and reliable positioning and retrieval of fishing rods that are difficult to remove from out of reach rod holders. Moreover, there is a need in the art of deep sea fishing for an effective method of retrieving any form of fishing rod when it appears that the fishing rod has engaged a fish.

### SUMMARY OF THE INVENTION

The invention provides a quick, safe and reliable means of positioning and retrieving fishing rods positioned within a rod holder located in a boat. The invention is directed to a fishing rod retrieval and positioning carriage comprising an engaging member having an opening, a top wall, a bottom wall, a first side wall and a second side wall which form a cavity. The top wall may be parallel to the bottom wall while the first side wall may also be parallel to the second side wall. The cavity formed by these various walls has a sufficient size and dimension to maintain a reel of the fishing rod.

The engaging member may also include a first channel located on the top wall of the engaging member—as well as an optional second channel located on the bottom wall both—having a first prong, a corresponding second prong and a stopper. Both prongs may be parallel to one another and include guides. Located on the bottom side of the engaging member is a positioning member capable of engaging a pole of the fishing rod. The positioning member may include a first portion and corresponding second portion that form a semi-circular passage.

The invention is further directed to a method of retrieving a fishing rod from a rod holder. The first step of the method may include positioning the carriage parallel to the rod holder so that the carriage is directly below the reel of the fishing rod. The second step contemplates encapsulating the reel with the cavity of the engaging member. This requires placing the reel within the opening formed by the top wall, bottom wall, first side wall and second side wall of the engaging member. Optionally, the method can include the step of engaging a positioning member located on the bottom wall of the engaging member on a pole of the fishing rod to enhance stability.

The third step is to contact the connector of the fishing rod with the stopper of the channel. Securing the connector to the stopper, in addition to placement of the reel within the cavity, helps lock the fishing rod within the carriage. The fourth step is to lift the handle upward to remove the fishing rod from the rod holder. An optional fifth step is to release the fishing rod from the carriage by removing the reel from the engaging member.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 illustrates the components of a traditional fishing rod for use in offshore boat fishing;

FIG. 2 illustrates the typical placement and positioning of rod holders on a fishing boat;

FIG. 3 is a side view of a carriage contemplated by the invention;

FIG. 4 is a top view of the carriage contemplated by the invention;

FIG. 5 is a front view of the carriage contemplated by the invention;

FIG. 6 illustrates the proper positioning of the carriage in relation to the rod holder prior to retrieval of a fishing rod; and

FIG. 7 illustrates the proper positioning of the carriage to retrieve and remove a fishing rod from a rod holder.

### DETAILED DESCRIPTION OF EMBODIMENTS OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Components of Both Sea Rods and Outriggers

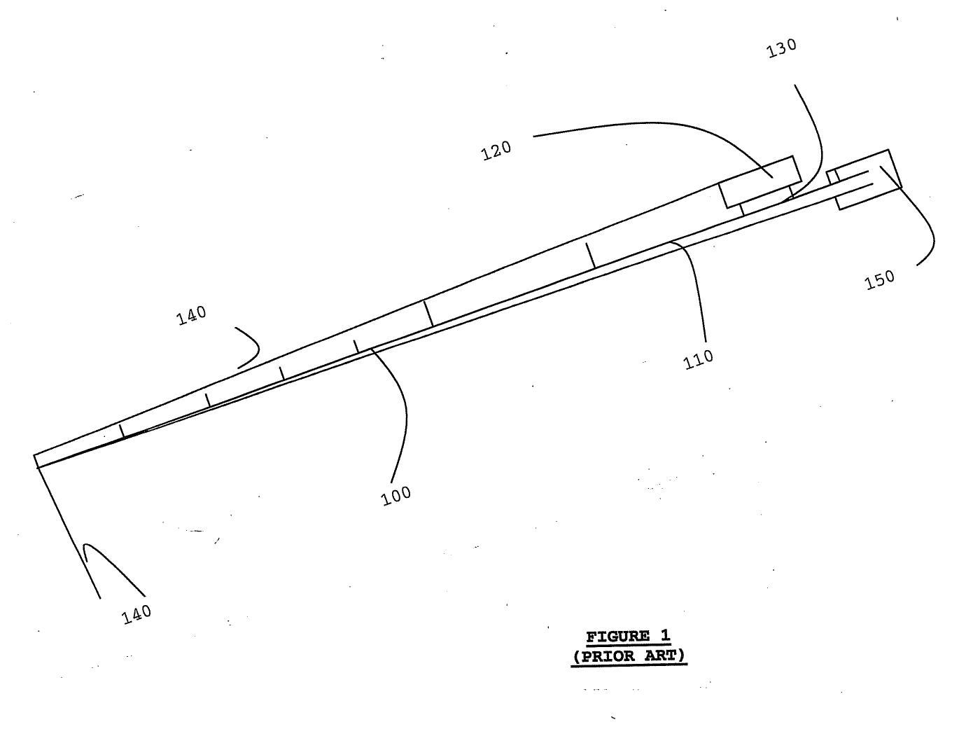

FIG. 1 provides, by way of example, the common components of a fishing rod 100 often used for offshore boat fishing. The fishing rod 100 may include, but is certainly not limited to, a pole 110, a reel 120, a connector 130, tackle 140 and a handle 150. The fishing rod 100 contemplated for use by the invention can be a trolling rod, deep sea fishing rod or any type of rod known and used by those in the art. As illustrated in FIG. 1, the reel 120 is rigidly connected to the pole 110 through a connector 130. Moreover, tackle 140 is drawn from the reel 120 and directed through various threads positioned along the pole 110. The tackle 140 is usually high strength composite capable of returning a large fish such as a tuna, dolphin or swordfish. The handle 150 is located at the distal end of the pole 110 for use by a fisherman.

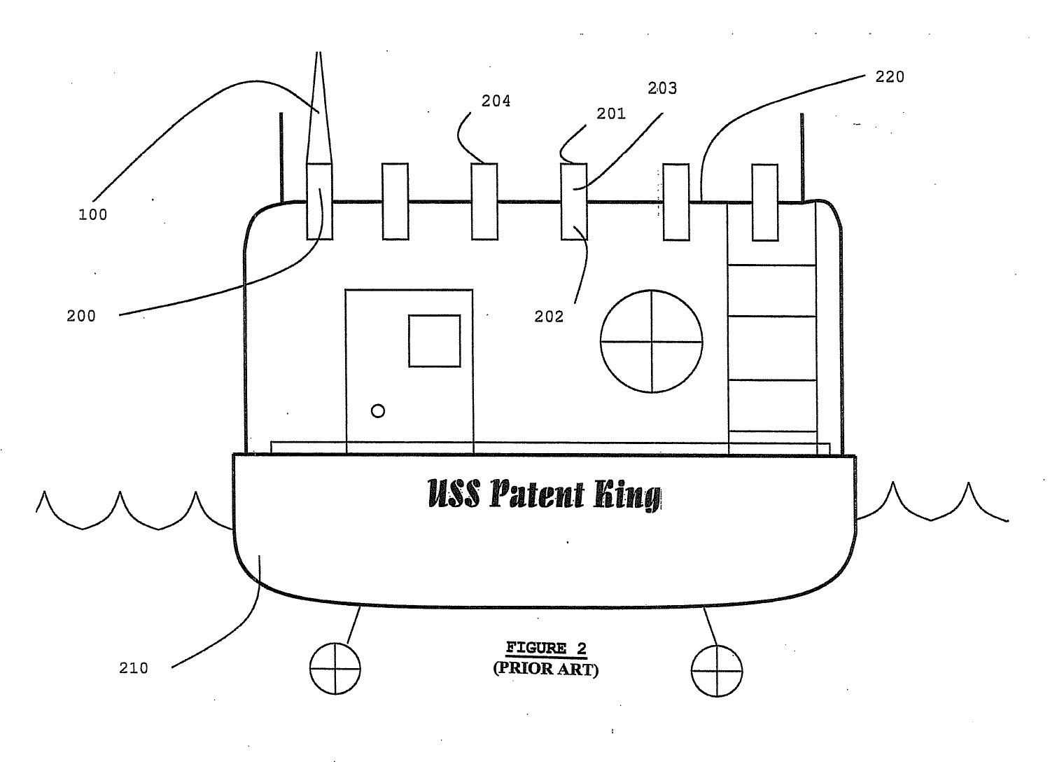

While FIG. 1 illustrates the main components of a fishing rod 100, FIG. 2 shows the proper positioning, location and structure of a fishing rod holder 200. As shown, the rod holders 200 are typically positioned in a high portion of an offshore fishing boat 210. The rod holders 200 are often placed on a balcony wall 220 positioned above the main floor and walking area of the fishing boat 210. Moreover, such rod holders 200 can be placed, positioned and affixed throughout the back and sides of a conventional fishing boat 210.

Most outriggers 200 are cylindrical in shape having a top side 201, a corresponding bottom side 202 and a sheath 203. Positioned at the top side 201 of the rod holder 200 is an opening 204. Both the opening 204 and sheath 203 have a sufficient size and dimension to maintain and secure the handle 150 of fishing rod 100 (shown in FIG. 1). The rod holder 200 is typically made of a hard, resilient and rustproof material such as PVC or other polymer material.

### The Carriage Assembly

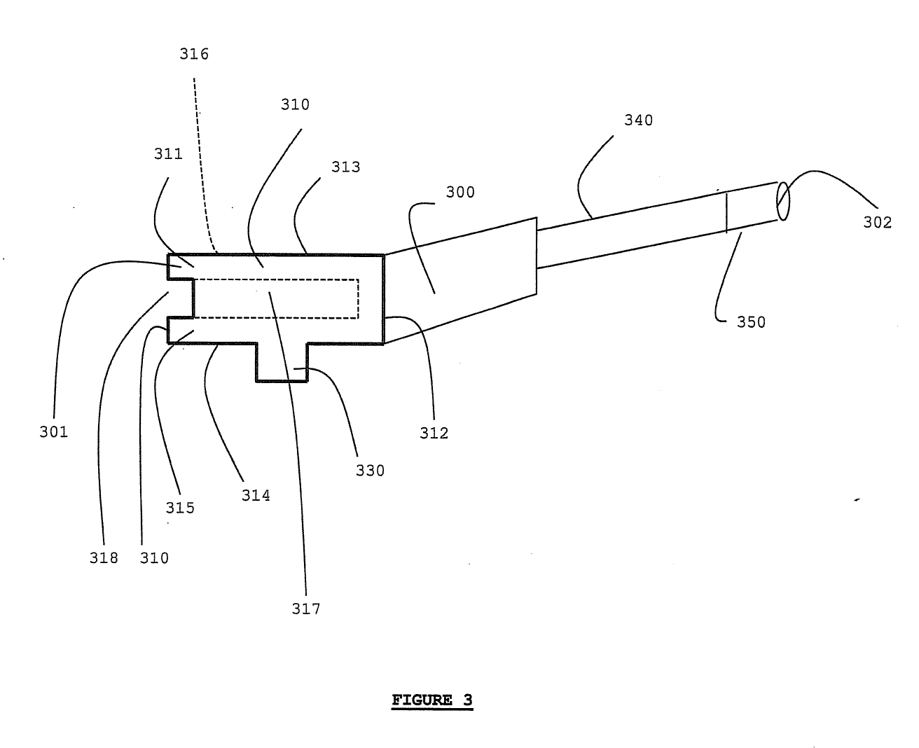

FIGS. 3 through 6 illustrate, by way of example, one embodiment of the preferred apparatus. First turning to FIG. 3, one form of the apparatus is a carriage assembly 300. The carriage assembly 300 may include an engaging head 310, a positioning clip 330, a shaft 340 and a grip 350. As shown, the carriage assembly 300 includes a first end 301 and corresponding second end 302. Other additional components will be recognized and understood by those of ordinary skill in the art upon review of the disclosures contained herein.

As further shown in FIG. 3, the engaging head 310 is positioned at the first end 301 of the carriage assembly 300. The engaging head 310 is essentially rectangular in shape and orientation and includes a front side 311 and a corresponding back side 312. In addition, the engaging head 310 may include a top wall 313, a corresponding bottom wall 314, a first side wall 315 and a corresponding second side wall 316. Here, the top wall 313 and bottom wall 314 are in parallel relation to one another. Similarly, the first side wall 315 is in parallel relation to the second side wall 316.

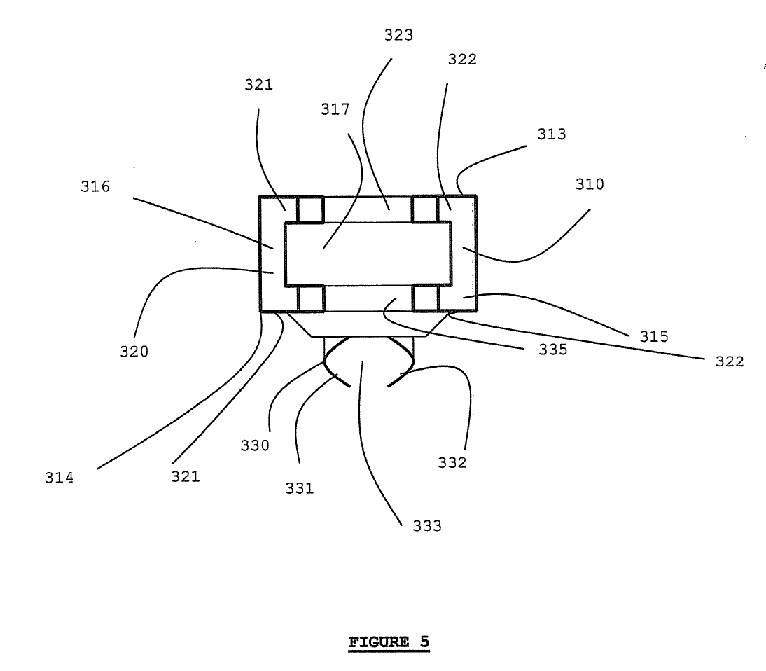

As further shown in FIG. 3, the various walls 313-316 of the engaging head 310 form a cavity 317 of sufficient size and dimension to surround and embrace the connector 130 of the rod 100 (shown in FIG. 1 described above and in FIG. 5 discussed below). In addition, the first side 311 includes an opening 318 sufficient to receive the reel 100.

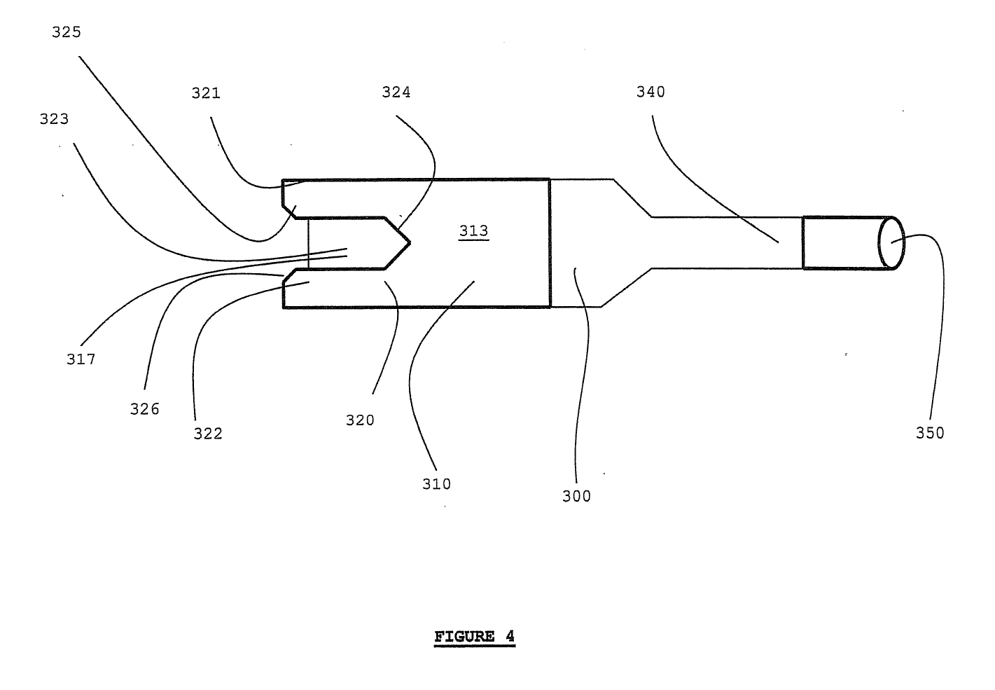

FIG. 4 offers a top view of the various components of the engaging head 310. As shown, the front of the engaging head 310 includes an engaging member 320. The engaging member 320 contains a first engaging prong 321, a corresponding second engaging prong 322 and a stopper 324. Both prongs 321 and 322 are located on the top wall 313 of the engaging head 310. Moreover, both prongs 321 and 322 are essentially parallel to one another and form a first channel 323.

As above described with reference to FIG. 4, the engaging member 320 further includes the stopper 324. The stopper 324 is perpendicular to (and located behind) both prongs 321 and 322—forming the end of the first channel 323. As illustrated, the stopper 324 is designed to lock and secure the reel 120 into the cavity 317 by engaging the connector 130.

Optionally both prongs 321 and 322 can include guides 325 and 326. More specifically, the first engaging prong 321 can include a first guide 325 while the second engaging prong 322 can include a second guide 326. Both guides 325 and 325 are angled or curved in order to help direct the connector 130 into the first channel 323. Moreover, the stopper 324 of the first channel 323 will engage the connector 130 to lock and secure the rod 100 into the engaging member 320.

FIG. 5 offers a front view of the engaging member 320 of the engaging head 310. In addition to illustrating the orientation of the cavity 317 formed through walls 313-316, FIG. 5 shows the positioning clip 330 of the carriage assembly 300 as well as an optional second channel 335. The positioning clip 330 includes a first portion 331 and a corresponding second portion 332 that form a semi-circular passage 333. Preferably, both portions 331 and 332 may be spring-loaded. This spring loaded, positioning clip 330 is capable of engaging and securing the pole 110 of the fishing rod 100.

FIG. 5 further illustrates a second channel 335 formed within the engaging head 310. As shown, the second channel 335 is positioned on the bottom wall of the engaging member 320. This second channel 335 is formed through a first engaging prong 321, a corresponding second engaging prong 332 and the stopper 324. Both prongs 321 and 322 have the same shape, size and configuration as those found on the top wall 313 of the engaging head 310. Moreover, both prongs 321 and 322 are essentially parallel to one another and form the second channel 335.

### Method of Use

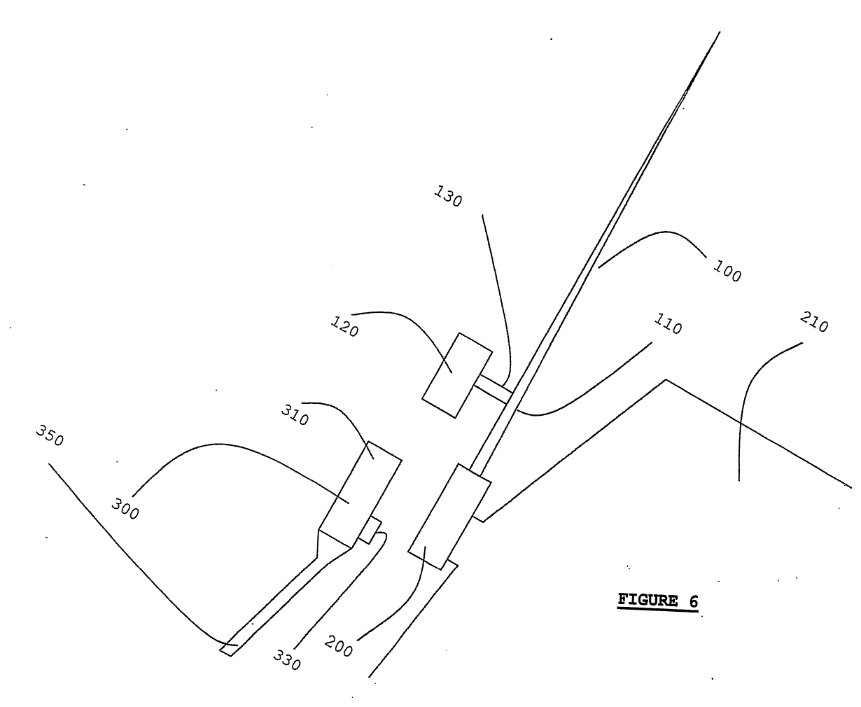

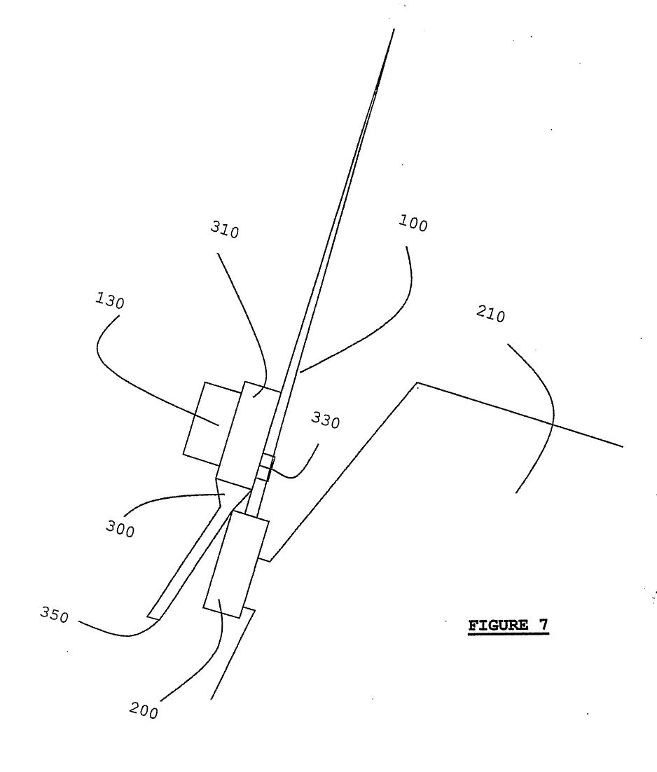

In addition to teaching a preferred device, the invention is also directed to a method to position and retrieve fishing rods 100 from rod holders 200 while fishing either off shore, in costal waters, on lakes, on rivers or any form of waterway. Both FIGS. 6 and 7 illustrate the preferred steps of the contemplated method. However, other related and/or additional steps will be recognized and understood by those of ordinary skill in the art upon review of FIGS. 1 through 7.

FIG. 6 helps illustrate the initial steps of the method. The first step of the method may include positioning the carriage 300 parallel to the rod holder 200 so that the carriage 300 is directly below the reel 110 of the fishing rod 100. The second step contemplates encapsulating the reel 110 with the cavity 323 of the engaging member 320. This requires placing the reel within the opening 318 formed by the top wall 313, bottom wall 314, first side wall 315 and second side wall 316 of the engaging member 320. Optionally, the method can include the step of engaging a positioning member 330 located on the bottom wall 314 of the engaging member 320 on a pole 110 of the fishing rod 100 to enhance stability.

FIG. 7 helps illustrate the other steps of the method. The third step is to contact the connector 130 of the fishing rod 100 with the stopper 324 of the first channel 323. Securing the connector to the stopper 324, in addition to placement of the reel 130 within the cavity 317, helps lock the fishing rod 100 within the carriage 300. The fourth step is to lift the handle 350 upward to remove the fishing rod 100 from the rod holder 200. A fifth step is to release the fishing rod 100 from the carriage 300 by removing the reel 130 from the engaging member 320.

That which I claim:

1. A carriage for retrieving and positioning a fishing rod from a rod holder, comprising:
an engaging member having a front, a top wall, a bottom wall, a first side wall and a second side wall which form a cavity, the cavity having a sufficient size and dimension to maintain a reel of the fishing rod; wherein the front of the engaging member includes an opening sufficiently sized to receive the reel;
a first channel located on the top wall of the engaging member having a first prong and a corresponding second prong; and
a handle affixed to the engaging member.

2. The carriage of claim 1, further comprising:
a second channel located on the bottom wall having a first engaging prong and a corresponding engaging second prong.

3. The carriage of claim 1, further comprising:
a positioning member positioned on the bottom side of the engaging member of sufficient size and dimension to engage a pole of the fishing rod.

4. The carriage of claim 2, wherein the positioning member includes a first portion and corresponding second portion which form a semi-circular passage.

5. The carriage of claim 4, wherein both the first portion and second portion are spring loaded.

6. The carriage of claim 2, further comprising:
a stopper positioned at the back of the first channel and the second channel that is perpendicular to both the first prong and the second prong.

7. The carriage of claim 2, wherein the first prong and second prong of the channel are parallel to one another.

8. The carriage of claim 7, wherein the first prong includes a first guide while the second prong includes a second guide.

9. The carriage of claim 1, wherein:
the first side wall of the engaging member is parallel to the second side wall.

10. The carriage of claim 1, wherein:
the top wall of the engaging member is parallel to the bottom wall.

11. A method of retrieving a fishing rod from a rod holder, the method comprising the steps of:
(a) positioning a carriage parallel to the rod holder such that the carriage is below a reel of the fishing rod; the carriage having
an engaging member having an opening, a top wall, a bottom wall, a first side wall and a second side wall which form a cavity, the cavity having a sufficient size and dimension to maintain a reel of the fishing rod,
a channel located on the top wall of the engaging member having a first prong, a corresponding second prong and a stopper, and
a handle affixed to the engaging member,
(b) encapsulating the reel of the fishing rod with the cavity of the engaging member,
(c) contacting a connector of the fishing rod with the stopper; and
(d) lifting the handle upward to remove the fishing rod from the rod holder.

12. The method of claim 11, further comprising the step of:
(e) releasing the fishing rod from the carriage by removing the reel from the engaging member.

13. The method of claim 11, further comprising the step of:
engaging a positioning member located on the bottom wall of the engaging member, on a pole of the fishing rod.

14. The method of claim 13, the positioning member includes a first portion and corresponding second portion which form a semi-circular passage.

15. The method of claim 11, wherein both the first portion and second portion are spring loaded.

16. The method of claim 11, further comprising:
the stopper positioned at the back of the channel that is perpendicular to both the first prong and the second prong.

17. The method of claim 11, wherein the first prong and second prong of the channel are parallel to one another.

18. The method of claim 17, wherein the first prong includes a first guide while the second prong includes a second guide.

19. The method of claim 11, wherein the first side wall of the engaging member is parallel to the second side wall.

20. The method of claim 11, wherein the top wall of the engaging member is parallel to the bottom wall.
